(19) United States
(12) Patent Application Publication
(10) Pub. No.: US 2004/0108789 A1
(43) Pub. Date: Jun. 10, 2004

(54) High torque brushless DC motors and generators

(76) Inventor: Eric Giles Marshall, Harrison Hot Springs (CA)

Correspondence Address: Eric G. Marshall, 410, 378 Esplanade Avenue, Harrison Hot Springs, BC, V0M 1K0, CA

(21) Appl. No.: 10/313,889

(22) Filed: Dec. 9, 2002

(51) Int. Cl. H02K 1/00

(52) U.S. Cl. 310/216

(57) ABSTRACT

This invention relates to geometric, electrical, and electronic techniques improving torque, power, cost, size, weight, reliability, and efficiency of electric generators and motors using the following: Geometric relationships eliminating lateral magnetic short circuits, providing sine wave output waveforms, and allowing axial extendibility; Radial and axial Permanent Magnet concentration; Speed independent rotating transformer inductive coupling; Precise speed independent rotor position sensing using a threshold and comparator circuit to provide Hall Effect low speed & Back-EMF medium to high speed sensing; Bi-directional Buck-Boost PWM converter topology using H-bridge power transistors, parallel reverse diodes and an H-bridge connected inductor.

The present invention relates to the unique combinations of well known techniques to optimize the torque, power, cost, size, weight, reliability, and efficiency of an electric generator and motor.

### BACKGROUND OF THE INVENTION

Electric motors and generators normally operate by interacting magnetic fields between two components, commonly referred to as a Rotor and a Stator.

It is well known that strategic use of a pole spacing relationship between the magnetic poles on the rotor and stator pole segments eliminates lateral magnetic short circuits allowing the construction of a dramatically more powerful apparatus and a trapezoidal geometric relationship between the rotor and stator poles provides a sine waveform that reduces cogging and losses associated with waveform harmonics in a rectangular or trapezoidal waveform. It is also known that the axial length of the rotor and stator can be increased by using axial windings or by axially stacking the components, and that the sine waveform can be achieved by a geometric relationship between the rotor and stator. What is not known is the method to provide a combination of these techniques resulting in a pole spacing, axial length, and sine waveform providing the required power, torque, size, weight, and efficiency.

Permanent magnets are ubiquitous in DC motors and generators. It is well known that the magnetic flux density necessary for high power motors and generators can be achieved using costly “Neodymium-lron-Boron” or rare-earth “Samarium-Cobalt” magnets and lateral magnetic flux concentration. What is not known is the method to provide the same or higher flux density using common, low cost, ceramic or flexible magnet materials using radial and axial magnetic flux concentration.

Rotating Inductive Couplers exist in many different types of motors and generators. The AC “Induction” Motor inductively couples the magnetic field into the rotor using a magnetically permeable rotor with strategically placed non-magnetic electrical conductors, typically laminated iron with aluminum or copper inserted into axial slots. This form of inductive coupling is beneficial in constant speed/load applications running on standard AC sine wave power at a fixed frequency. Variable speed control requires complex, costly, electronic controllers to provide the variable frequency and amplitude sine wave required for efficient operation. Modern Alternators use a stationary electromagnet coupled to the rotor via proximity, a technique very similar to the rotating electromagnet used in early alternators, but avoiding the need for brushes and slip rings. However, the technique restricts axial length, axial stacking, and the hollow “ring-like” structure. Generators use an “Excitation” coil rotating within a magnetic field that provides electrical power to the rotor and are designed for fixed speed applications with no regulation. What is not known is the method of providing a “Speed Independent, Regulating Inductive Coupler” with no axial length limitations using a Rotating Transformer, Electronic Chopper, and Rectifier.

Variable speed motors require a large range of voltage and current inputs to provide efficient torque control, and variable speed generators output voltage and current proportional to speed, magnetic field strength, and internal resistance. Electrical storage devices supply and accept electrical power most efficiently at a fixed voltage and current. Electronic “Pulse Width Modulation” control circuits are well known and commonly used to regulate the voltage and current by switching into an inductor or transformer at high frequency. “Buck” converters efficiently limit the current, but always provide a lower voltage than the source. “Boost” converters provide higher voltages but don't provide current limiting. “Buck-Boost” converters provide control of both current and voltage but are inefficient and invert the output. What is not known is the method of providing “Bi-Directional Buck-Boost” conversion that provides efficient voltage/current matching and control that is continuously variable up to the limits of electrical apparatus.

A “Brushless DC Motor” requires Rotor Position Sensing to precisely control the power transistors providing commutation. Electronic circuits with the logic for electromechanical (“Hall Effect”, “Optical”, or other) sensors are common, providing speed independent control, but are fragile, require alignment, and have limitations on control. “Back-EMF” sensing circuits are also common, using “Phase-Locked-Loops” and other digital/analog circuits providing more precision and control at medium to high speeds, but have severe limitations providing accurate sensing at low speeds. What is not known is the method of providing precision sensing and control at all speeds with a “Threshold and Comparator” circuit that uses Hall Effect sensors for low speed operation, and then switches to a “Back-EMF Comparator” after the Back-EMF has reached a predetermined threshold.

### BRIEF DESCRIPTION OF THE DRAWINGS

These and other features of the invention will become more apparent from the following drawing descriptions:

FIG. 1 is a cross-sectional side view of a wound rotor motor and generator using axial windings.

FIG. 2 is an expanded cross-sectional end view representing a portion of the rotor and stator of FIG. 1.

FIGS. 3a-3j show expanded cross-sectional side views illustrating geometric relationships between the rotor and stator that detail alternative methods to eliminate lateral magnetic short circuits, provide an extendable axial length, and induce a sine waveform in the main windings.

FIG. 4 is prior art illustrating an expanded cross-sectional end view of a portion of a wound rotor and matching stator with magnetic short circuits.

FIG. 5 is a complete cross-sectional end view of a 12-pole axial wound rotor and matching 3-phase stator.

FIG. 6 is an expanded cross-sectional end view of a permanent magnet rotor and matching stator illustrating a radial concentration factor of approximately two to one.

FIGS. 7a-7f illustrate a progressive analysis of the different surfaces that contribute to the concentration of magnetic flux in a single pole.

FIG. 8 is a full cross-sectional side view of a permanent magnet motor and generator illustrating axial concentration.

FIG. 9 is an expanded cross-sectional end view of two poles of a permanent magnet rotor and 3-phase stator illustrating a radial concentration factor of approximately four to one.

FIGS. 10a and 10b illustrate a permanent magnet “claw” rotor allowing radial concentration and axial stacking. FIG. 10c illustrates a similar axially stackable “claw” structure using radial windings to provide the magnetic field.

FIG. 11 illustrates a prior art, surface mounted high strength permanent magnet rotor with limited lateral magnetic flux concentration in the iron cap.

FIG. 12 is a cross-sectional side view of a permanent magnet motor and generator illustrating an axially stacked claw structure.

FIG. 13 is an expanded side view illustrating the rotating inductive coupler transformer.

FIG. 14 is a schematic diagram of an electronic threshold and comparator circuit illustrating a method for providing electromechanical (Hall Effect) and Back-EMF rotor position sensing.

FIGS. 15a-15d are schematic diagrams of 3-phase Brushless DC motor controllers available from semiconductor manufacturers that illustrate Hall Effect sensing prior art.

FIGS. 16a-16d are schematic diagrams of “Buck” and “Boost” converters illustrating a progression from prior art to a “Bi-directional Buck-Boost” converter using standard “H-bridge” power MOSFET transistor modules.

FIGS. 17a-17c are schematic diagrams of Pulse Width Modulation (PWM) controllers available from semiconductor manufacturers that illustrate readily available circuits supporting various Buck and Boost topologies.

### DETAILED DESCRIPTION OF THE PREFERRED EMBODIMENT

### Pole Spacing-Sine Wave-Axial Extendibility

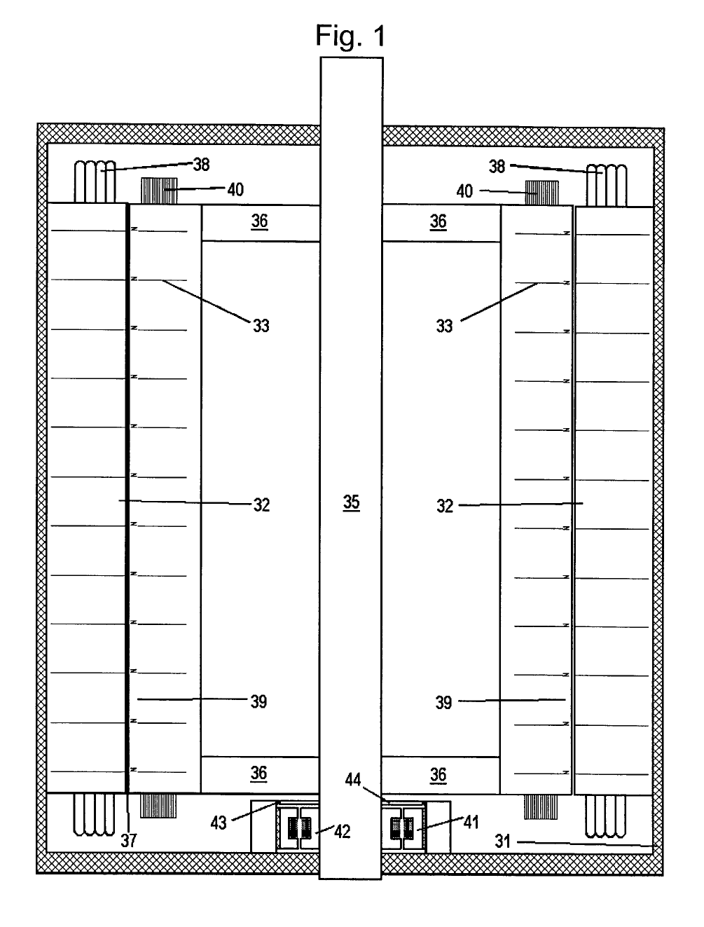

The preferred embodiment of the high torque brushless DC motor/generator is now described with reference to FIGS. 1-5.

The novel aspects of this part of the invention relates to the combination of; a lateral pole spacing relationship to eliminate lateral magnetic short circuits, a geometric relationship between the rotor and stator that creates a sine waveform in the main windings, and an axial extendibility that provides the required power.

Referring to FIG. 1 there is illustrated a cross-sectional side view of a complete axially wound rotor motor and generator. Rotating transformer primary 41 and secondary 42 inductively couple electric current to windings 40. Hall Effect sensors 43 and magnetic reluctor wheel 44 provide rotor position sensing. This apparatus is similar to an automotive alternator except that the rotor is significantly altered, allowing a hollow “ring-shaped” construction and no practical axial length limitation of the rotor or stator poles.

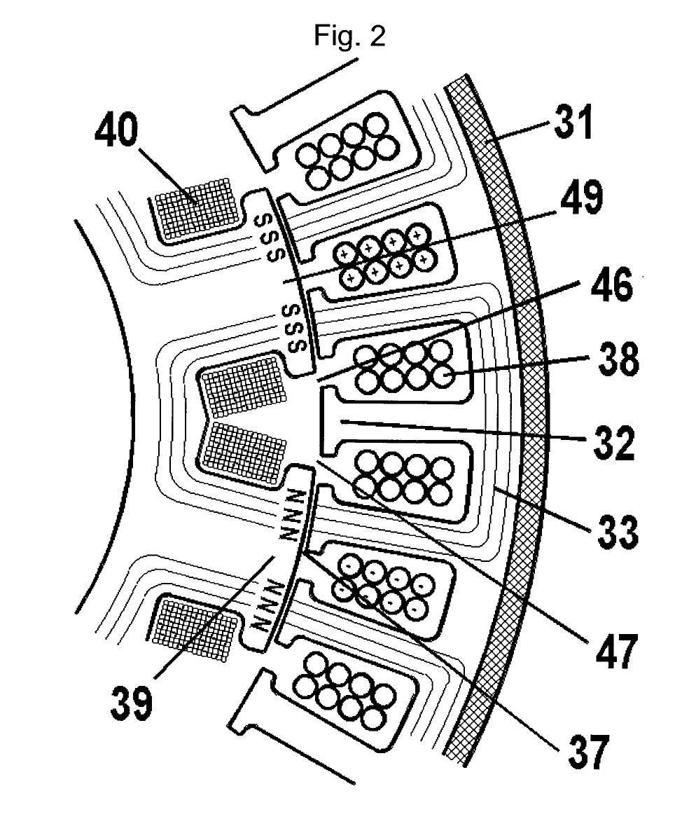

Referring to FIG. 2 there is illustrated an expanded cross-sectional view of two poles of a 12-pole wound rotor and seven pole segments of a 12-pole, 36-segment, 3-phase stator in the preferred embodiment. The rotor and stator are separated by gap 37 such that the rotor freely moves past the stator. The windings 40 are arranged such that North and South poles are electromagnetically induced into pole pieces 39 and 49, as is indicated by the letters “N” and “S”. The stator is comprised of a housing 31 within which is attached a magnetically permeable material (typically insulated iron laminations to prevent eddy currents) containing equally spaced slots for wires 38 forming pole segments 32. Three pole segments 32 are required to form a complete pole that matches the pole pieces 39 & 49 on the rotor.

Magnetic flux indicated by lines 33 emanates from rotor pole piece 39. It is conducted across gap 37 into stator pole segment 32, around the slots for stator wires 38 and into second adjacent stator pole segment 32. It continues across gap 37 into adjacent rotor pole piece 49 where it continues around the slots for rotor wires 40 into rotor pole piece 39 forming a closed magnetic circuit.

A lateral spacing between rotor pole pieces 39 & 49 forms lateral gaps 46 & 47 between the rotor pole pieces 39 & 49 and the stator pole segment 32. These lateral gaps prevent magnetic flux 33 from laterally short circuiting across stator pole segment 32, allowing the magnetic flux 33 to go around the slots for stator wires 38. As the rotor turns within the stator, the lateral spacing between rotor pole pieces 39 & 49 is always sufficient to prevent a lateral magnetic short circuit through stator pole segment 32 or any adjacent stator pole segment 32.

An electrical current in wires 38 indicated by “+” and “−” in the expanded view, creates a right angle force between the rotor and stator. To someone skilled in the art, it will be obvious that the illustrated 3-phase stator is identical to that used in an automotive alternator. The preferred embodiment allowed by the teachings of this invention illustrates that the rotor is significantly altered from that of an automotive alternator, allowing a hollow “ring-shaped” construction with no practical limitation in the length of the poles in the rotor and stator. By comparison, an automotive alternator has north and south magnetic poles formed by trapezoid shaped fingers attached to one central electromagnet. The trapezoid fingers have an inherent length limitation and the central electromagnet contains significantly more bulk than the preferred embodiment.

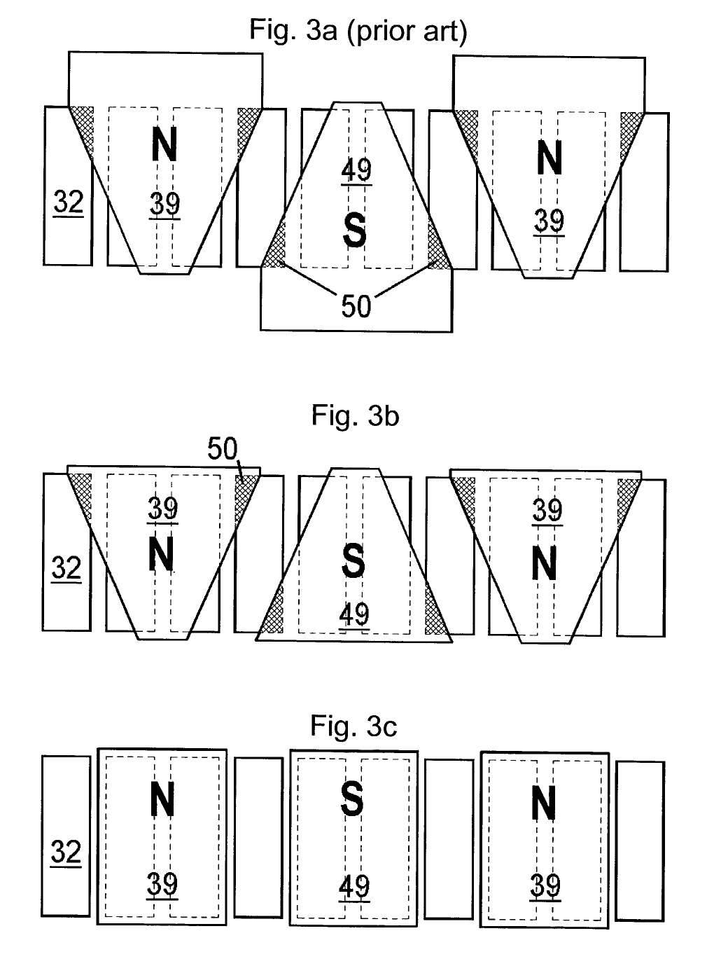

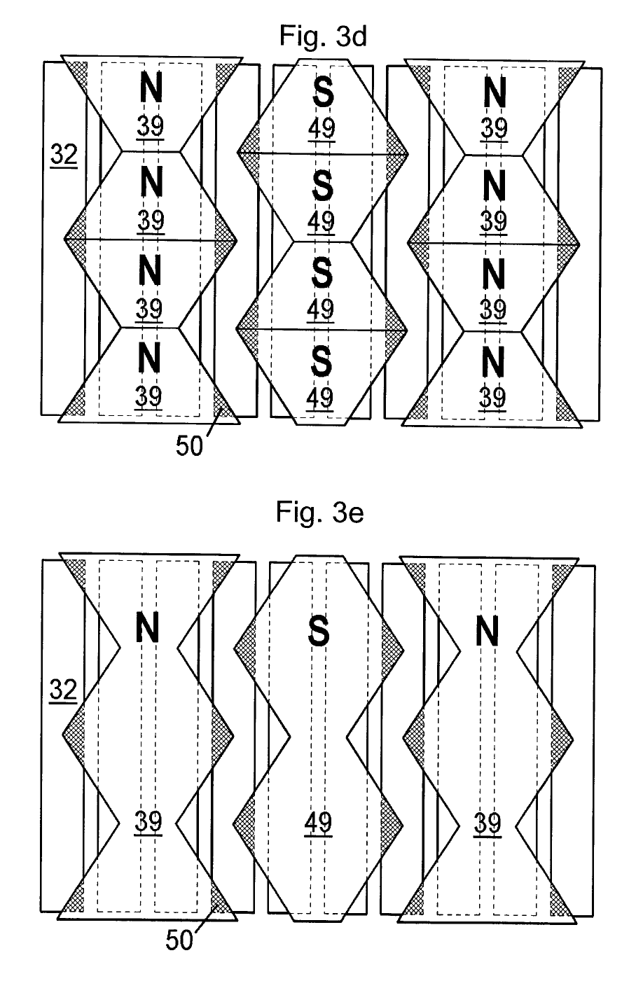

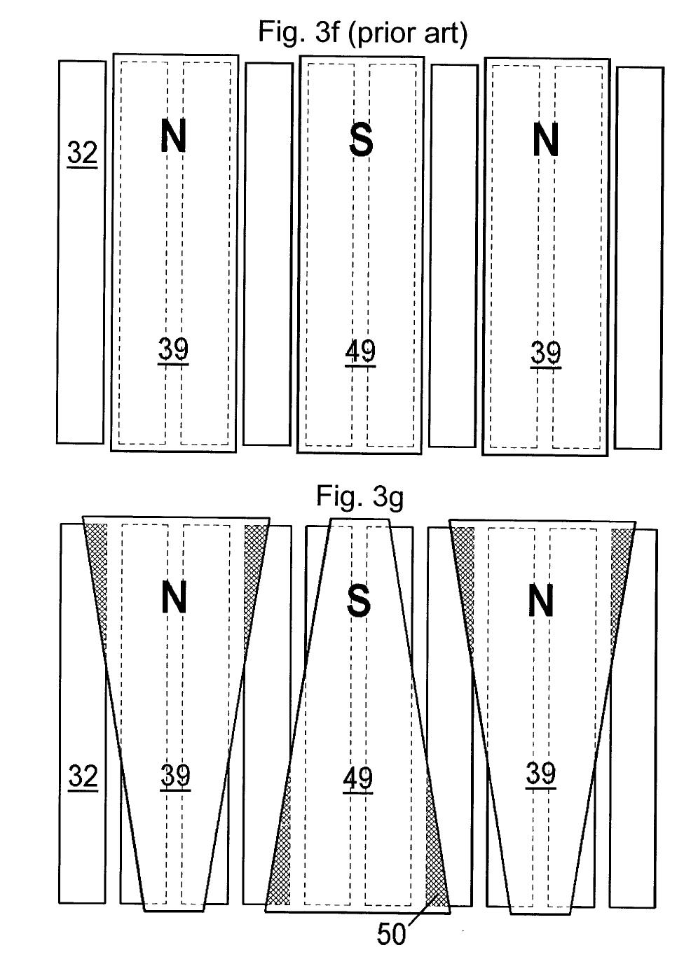

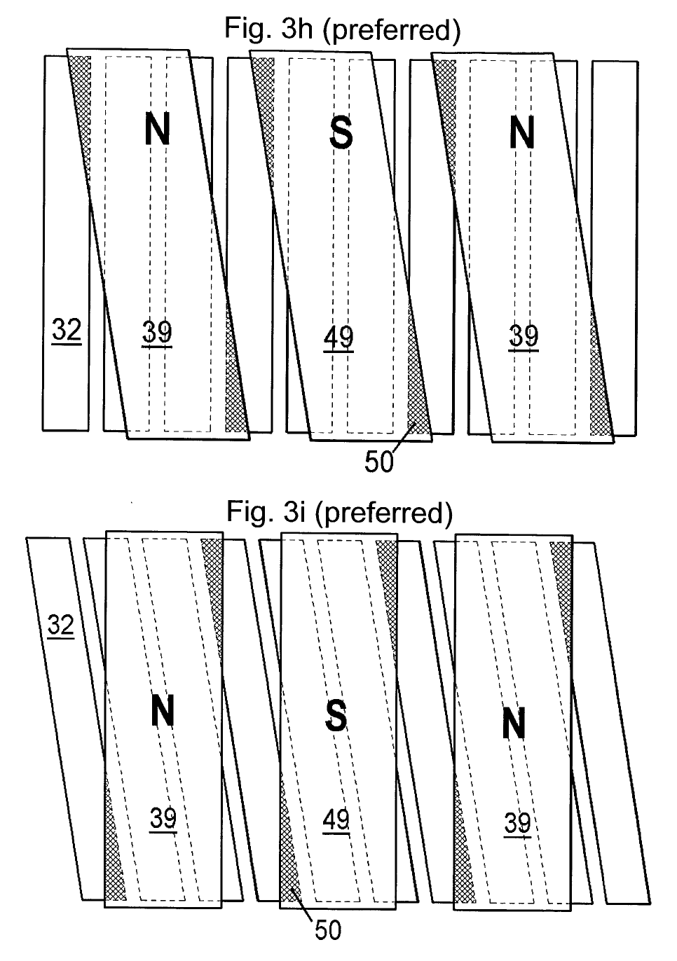

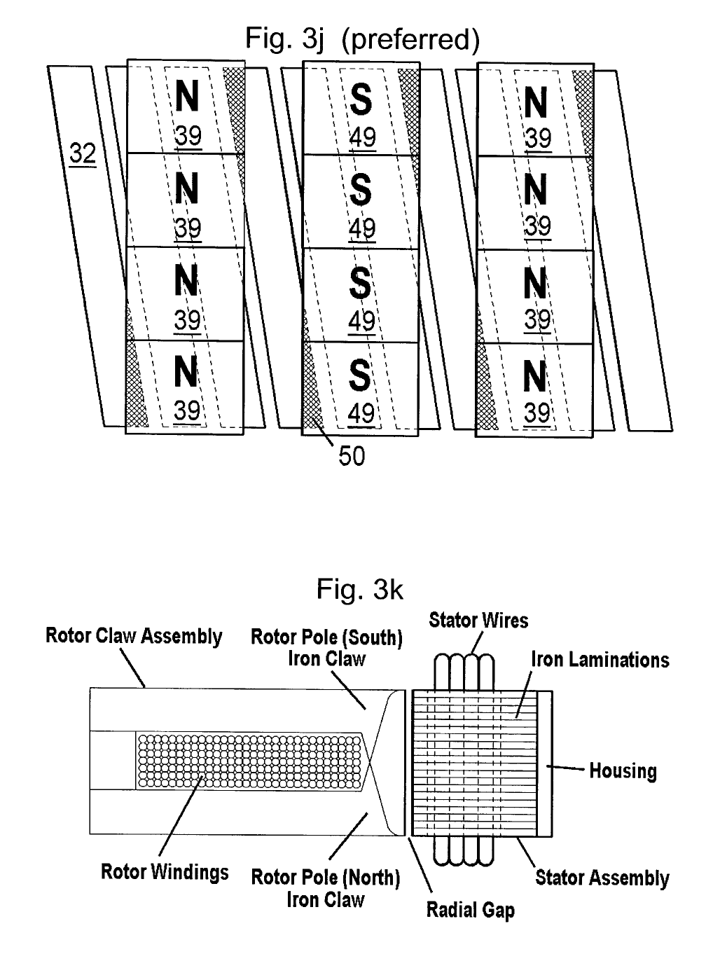

Referring to FIG. 3a (prior art) there is illustrated an expanded side view of the trapezoidal poles 39 and 49 formed by the fingers of an automotive alternator “claw” rotor superimposed on the pole segments 32 formed by the wiring slots in the stator. The poles are magnetized north 39 and south 49 indicated by the letters “N” and “S” as is common in an automotive alternator, from a central electromagnet which is not shown. The shaded area 50 indicates an axial magnetic short circuit that is conducted from the north rotor pole 39 through the stator pole segment 32 and back through the south rotor pole 49. The axial magnetic short circuit detracts from the amount of magnetism that conducts around the wiring slots in the stator, but is necessary to achieve a sine wave. FIG. 3b illustrates a claw rotor with trapezoidal shaped poles and matching stator with the same axial length, making it axially stackable. FIG. 3c illustrates a claw rotor with rectangular shaped poles and matching stator with the same axial length, making it axially stackable. FIG. 3d illustrates one method of eliminating the axial length restriction by axially stacking the rotor poles in FIG. 3b. FIG. 3e illustrates an axial wound rotor with overall pole geometry equivalent to FIG. 3d. FIG. 3f illustrates prior art; an axial wound rotor (no axial length restriction), but with a rectangular geometric relationship to the stator that creates a square or trapezoidal waveform in the stator windings. FIG. 3g illustrates one method of creating a sine waveform by using an axial wound rotor and an axially extended trapezoidal rotor pole geometry. The effect of the axial short circuit is reduced due to the distance the magnetism must conduct through the stator pole segment, but for the same reason the power and efficiency is reduced due to the need for magnetic flux to conduct axially instead of laterally. FIG. 3h illustrates one method of creating a sine waveform in an axially wound rotor by skewing the rotor forming a parallelogram geometric relationship. FIG. 3i illustrates one method of creating a sine waveform in an axially wound rotor by skewing the stator forming a parallelogram geometric relationship. FIG. 3j illustrates one method of creating a sine waveform in a stacked rectangular claw rotor by skewing the stator forming a parallelogram geometric relationship. FIGS. 3h-3j are preferred since the lateral magnetic flux conduction is uniform and the effect of the axial magnetic short circuit is reduced due to the axial distance the magnetism must conduct through the stator pole segment. FIG. 3k illustrates the side view of the radial wound claw rotor in FIGS. 3b-3d & 3j and matching stator with the same axial length, making it axially stackable.

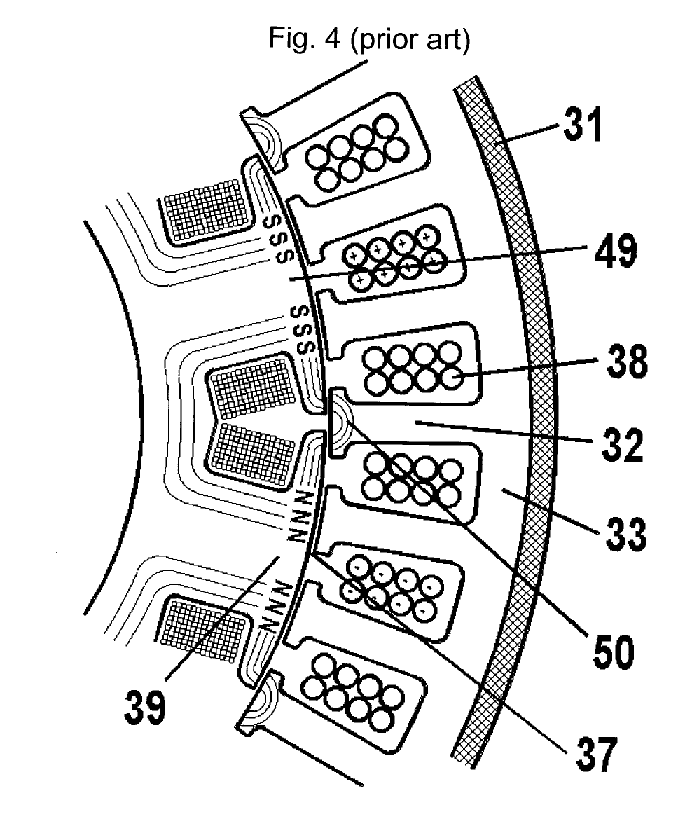

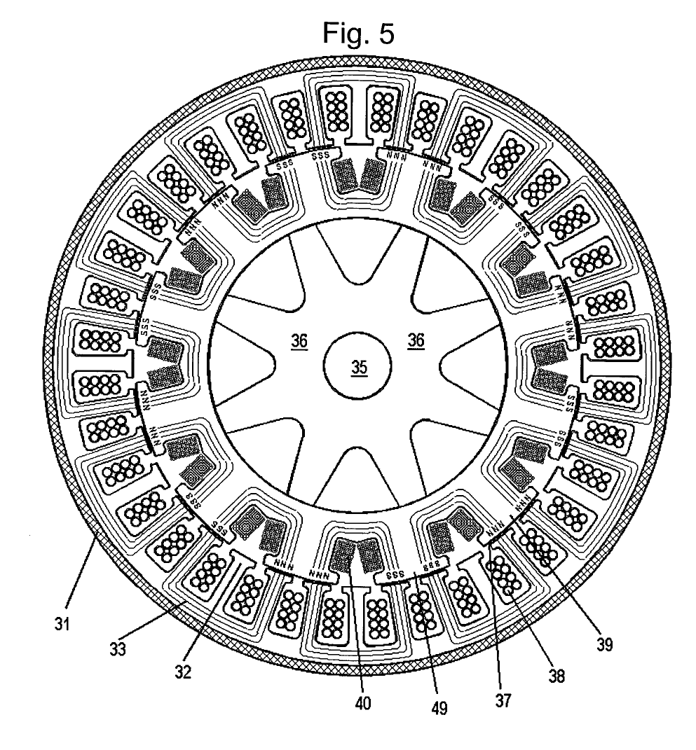

Referring to FIG. 4 (prior art) there are illustrated magnetic short circuits in expanded cross-sectional views of two poles of a 12-pole wound rotor and seven pole segments of a 12-pole, 36-segment, 3-phase stator. FIG. 4 is similar to FIG. 2 except that the lateral spacing between the rotor poles is reduced. This allows magnetic lines of force from rotor north pole 39 to short circuit laterally through stator pole segment 32 and back through rotor south pole 49 instead of extending around stator slots for wires 38, significantly reducing power and efficiency.

Referring to FIG. 5 there is illustrated a complete cross-sectional end view of a 12-pole wound rotor disposed within a matching 3-phase stator separated by gap 37 such that the rotor freely rotates within the stator. The rotor is comprised of a shaft 35 and non-magnetic hub 36 on which are positioned twelve equally spaced slots for wires 40 forming twelve magnetically permeable poles 39 & 49. The windings 40 are arranged such that North and South poles are electromagnetically induced into poles 39 & 49, as is indicated by the letters “N” and “S”. This is a complete view of the expanded illustration shown in FIG. 2.

### Permanent Magnet Concentration

In some applications, the extra efficiency and reduced complexity of permanent magnets is beneficial. Permanent magnets can be substituted for electromagnetically induced magnetic fields without affecting the magnetic pole geometric relationships, eliminating rotor windings and the need for electrical coupling of power to the rotor. The maximum torque and power of the device depends on the magnetic flux density and resistance to demagnetization of the permanent magnets used. The novel aspect this part of the invention relates to the concentration of magnetic flux in the pole pieces and how this affects the interaction between the rotor and stator.

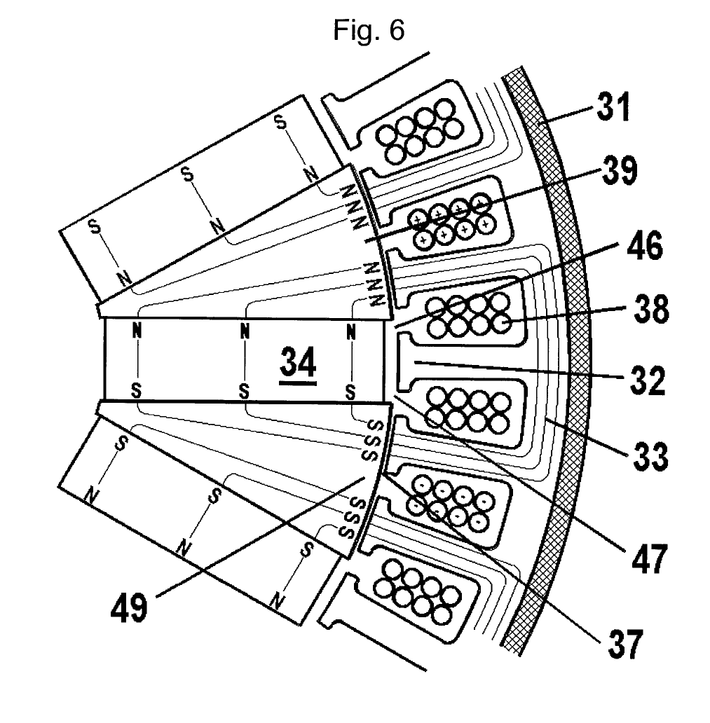

Referring to FIGS. 6-12 there are illustrated, cross-sectional views of a cylindrical 12-pole permanent magnet rotor disposed within a 3-phase stator separated by gap 37 such that the rotor freely rotates within the stator. The rotor is comprised of a shaft 35 and non-magnetic hub 36 on which are positioned 12 equally spaced magnetically permeable pole pieces 39 & 49 and permanent magnets 34. The permanent magnets are arranged such that adjacent poles are polarized opposite magnetic North 39 and South 49, as is indicated by the letters “N” and “S”. The stator is comprised of a housing 31 within which is attached a magnetically permeable material (typically insulated iron laminations to prevent eddy currents) containing thirty-six equally spaced slots for wires 38 forming thirty-six pole segments 32. In a 3-phase stator, three pole segments 32 are required to form a complete pole that matches the pole pieces 39 & 49 on the rotor. Magnetic flux (indicated by lines 33) emanates from permanent magnet 34, into the rotor pole piece 39 where it is concentrated and conducted across gap 37 into stator pole segment 32, around the slots for stator wires 38, into second adjacent stator pole segment 32 and back across gap 37 into adjacent rotor pole piece 49 where it is de-concentrated back into permanent magnet 34, forming a closed magnetic circuit.

Referring to FIG. 6, magnetic flux 33 is illustrated in the radial direction, the concentration factor in this direction being the ratio of the radial depth of the two permanent magnets 34 which are coupled to rotor pole piece 39 versus the arc length of the curved portion of the same rotor pole piece 39 that is in close proximity to the stator pole segments 32. In the radial direction, the concentration is approximately three to one.

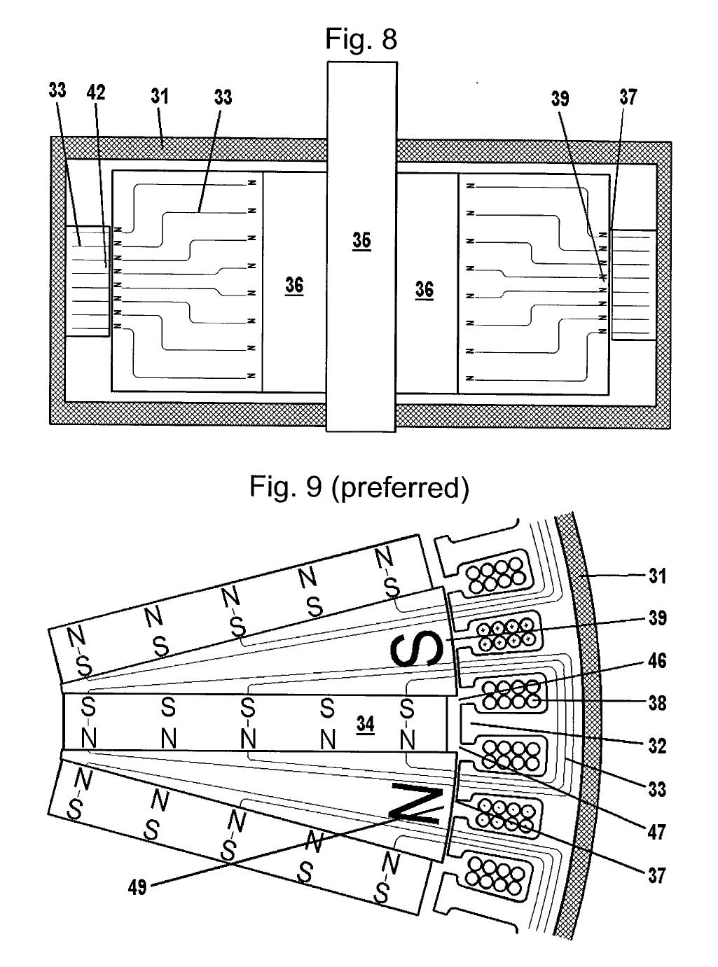

Referring to FIG. 8, magnetic flux 33 is illustrated in the axial direction, the concentration factor in this direction being the ratio of the axial length of the two permanent magnets 34 which are coupled to rotor pole piece 39 versus the axial length of the curved portion of the same rotor pole piece 39 that is in close proximity to the stator pole segments 32. In the axial direction, the concentration is approximately two times. The overall concentration factor is six to one since the ratio of areas is the multiplication of length and depth.

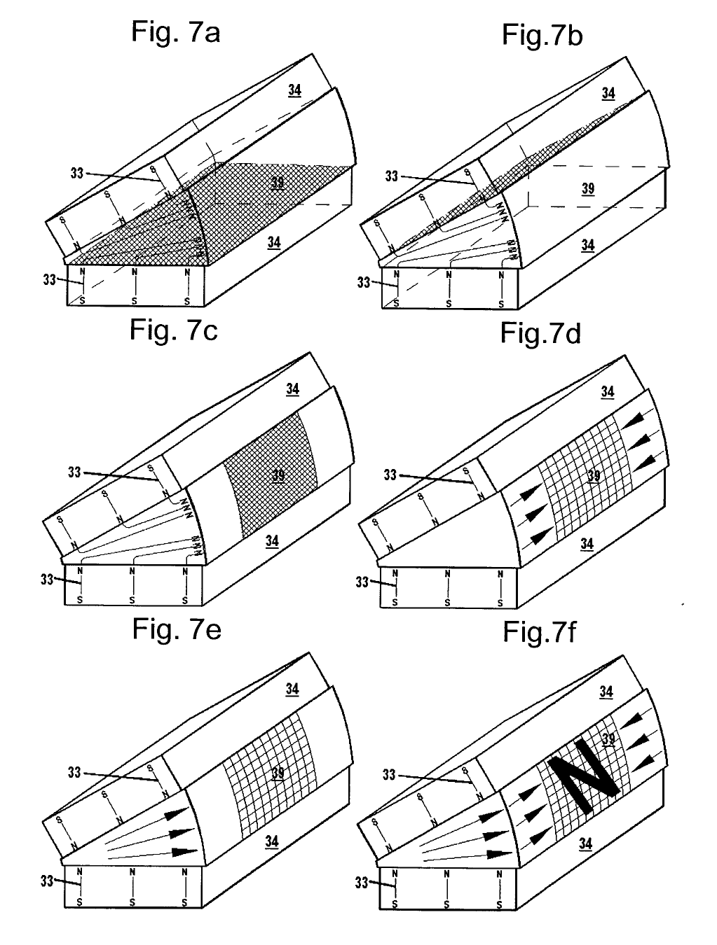

Referring to FIGS. 7a-7f there is illustrated a progressive analysis of the concentration that occurs in a single pole piece 39. The cross-hatched region of FIG. 7a illustrates the North pole of permanent magnet 34 being coupled to the bottom of pole piece 39. In a similar manner FIG. 7b illustrates the North pole of adjacent permanent magnet 34 coupled to the top of pole piece 39. The cross-hatched region of FIG. 7c illustrates the area that interacts magnetically with the stator pole segments. The arrows in FIG. 7d illustrate the concentration in the axial direction, and in FIG. 7e, the concentration in the radial direction. The large “N” in FIG. 7f illustrates the overall concentration of magnetic flux indicated by arrows in both the radial and axial directions.

An electrical current in wires 38 (indicated by “+” and “−”in the expanded view) creates a right angle force between the rotor and stator. To someone skilled in the art, it will be obvious that the illustrated 3-phase stator is virtually identical to that used in an automotive alternator. This apparatus is in fact, very similar to an alternator, except that the rotor is significantly altered. By comparison, in an automotive alternator, opposite north and south magnetic poles are formed in adjacent trapezoidal shaped fingers attached to one central electromagnet.

Referring to FIG. 9 there is illustrated an expanded cross-sectional end view of two poles of a 24-pole permanent magnet rotor disposed within a matching 3-phase stator, similar to the apparatus illustrated in FIG. 6. The drawings illustrate greater concentration in the radial direction and no concentration in the axial direction. The ratio of the radial depth of the two permanent magnets 34 which are coupled to rotor pole piece 39 versus the arc length of the curved portion of the same rotor pole piece 39 that interacts magnetically with stator pole segments 32 is approximately six to one. This provides as much concentration from only the radial direction, as the apparatus in FIGS. 6 & 7 obtain from both the radial and axial direction. Therefore the rotor can be extended axially, since a concentration in the axial direction is not required to achieve the same overall concentration factor.

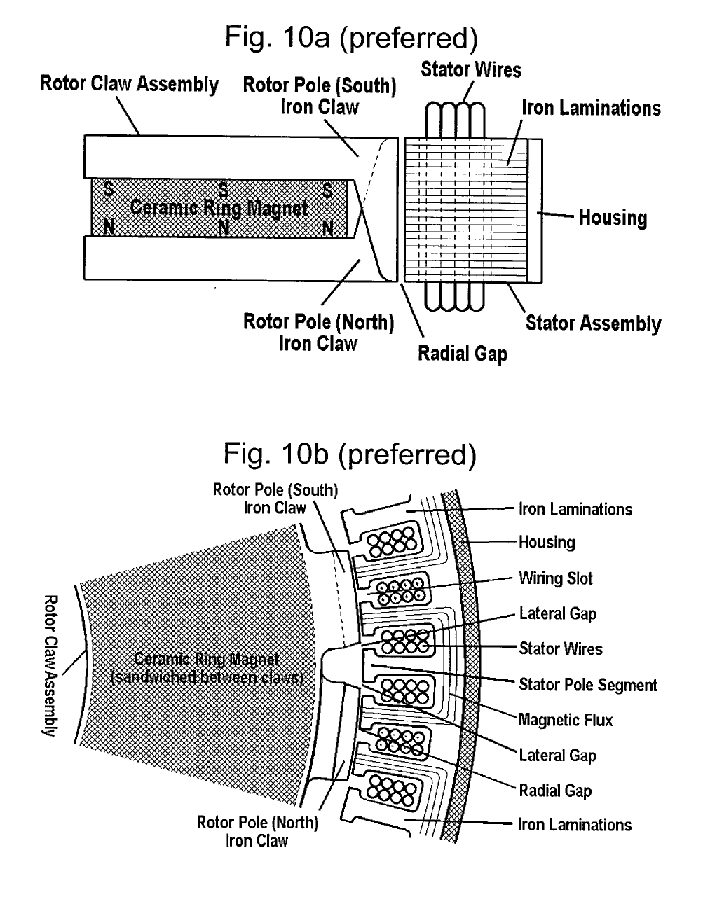

FIG. 10a & 10b illustrates a permanent magnet claw rotor with rectangular shaped poles and matching stator with the same axial length, making it axially stackable. FIG. 10a illustrates an expanded side view of magnetic flux concentration in the radial direction in the claw rotor of approximately six to one. FIG. 10b illustrates an expanded end view of the claw rotor show magnetic flux concentration in the radial direction.

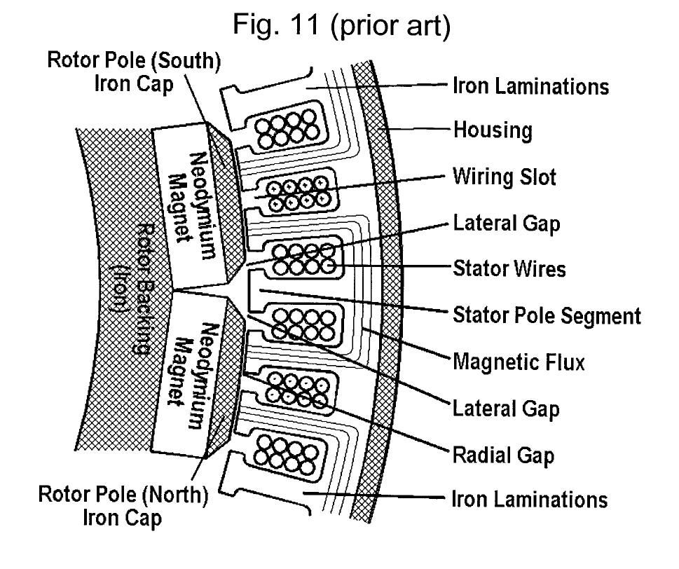

FIG. 11 illustrates prior art in an expanded cross-sectional end view of two poles of a surface mounted Neodymium permanent magnet rotor disposed within a matching 3-phase stator. The drawings illustrate concentration in the lateral direction only. The ratio of the lateral width of the high strength magnet versus the lateral width of the iron pole cap is approximately four to three achieving a concentration factor of four to three.

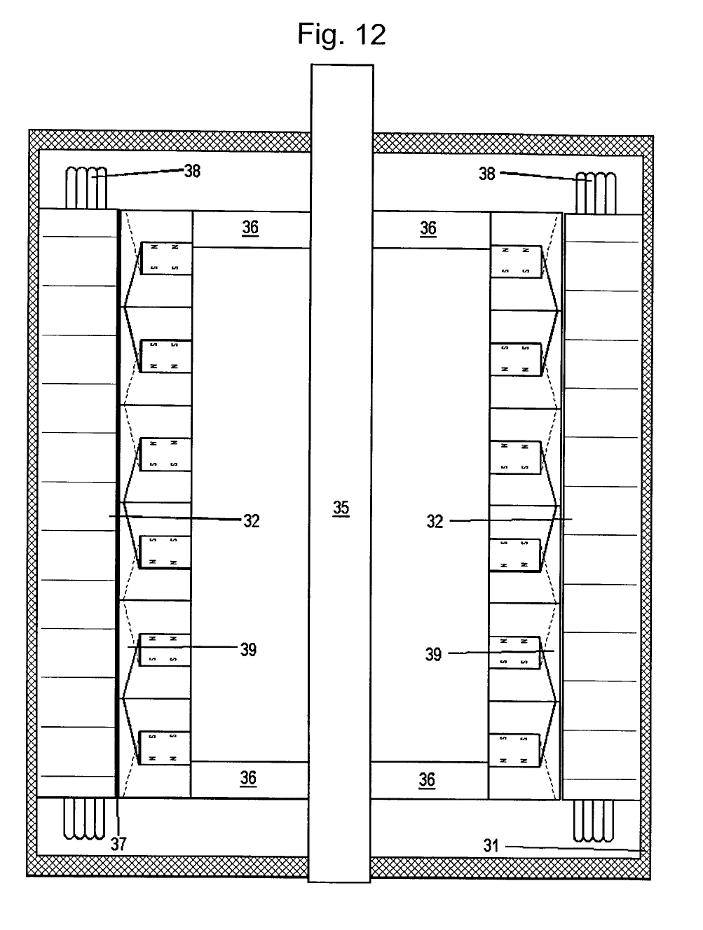

FIG. 12 illustrates a complete cross-sectional side view of a stacked claw permanent magnet generator with no practical restrictions on axial extendibility.

### Speed Independent Rotating Inductive Coupler

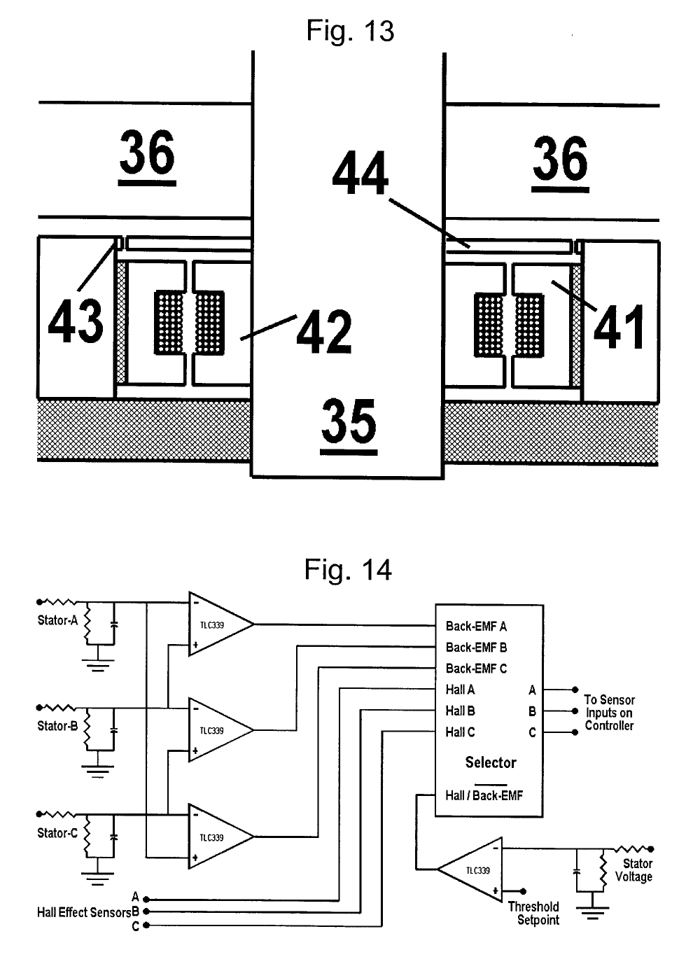

FIG. 13 illustrates a cross-sectional side view of a rotating transformer. The primary of the transformer core 41 is stationary, attached to the end plate by a hub. The secondary of the transformer core 42 is attached to the shaft and rotates with the entire rotor assembly. The core material is high frequency ferrite, powdered iron or other non-grain oriented magnetically permeable material. Windings within the core material in both the primary and secondary are radial wound and form the equivalent of a standard “C-shaped” stationary transformer. An alternating current in the primary will induce an equivalent current in the secondary, in a similar way to common C-shaped stationary transformers. An electronic chopper circuit converts the DC input voltage into AC that is coupled to the primary of the rotating transformer. A rectifier is mounted on the rotor that converts the AC output from the secondary of the rotating transformer to DC that is filtered and applied to the rotor windings. A change to the DC input voltage will affect the magnitude of the AC voltage applied to the primary of the rotating transformer, producing the same change in magnitude of the AC output from the secondary of the rotating transformer, producing an equivalent change in the DC voltage applied to the rotor windings.

It will be obvious to one skilled in the art that the electronic chopper circuit can be a “push-pull” configuration to work with a bifilar winding in the transformer primary, or an “H-bridge” configuration to work with standard windings. It is also obvious that a rotor mounted bridge rectifier will work with standard windings in the transformer secondary, or a “push-pull” diode rectifier will work with bifilar windings. It is also obvious that with minor changes to the transformer core, the inductive coupling can be radial or axial, or that core can be “E-shaped” as is common in higher power stationary transformers.

### Precision Speed Independent Rotor Position Sensing

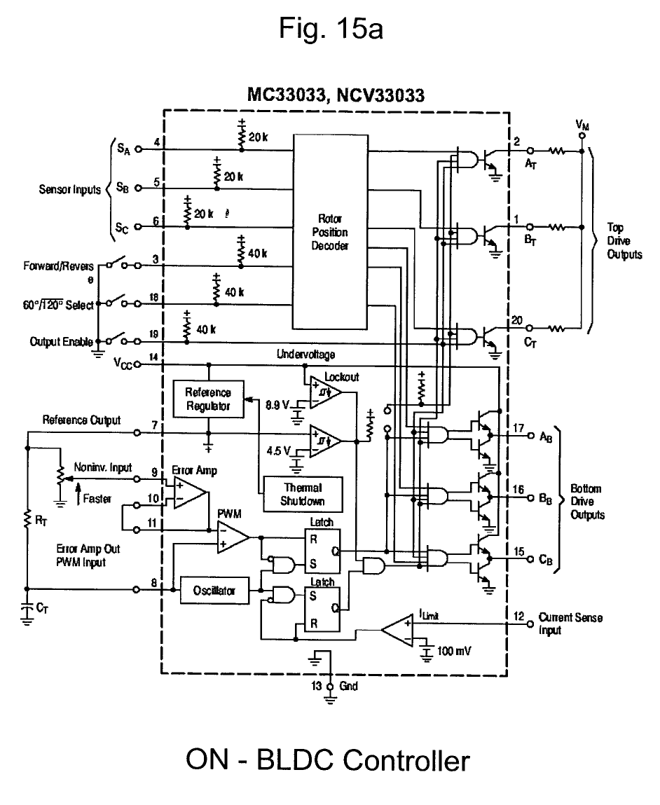

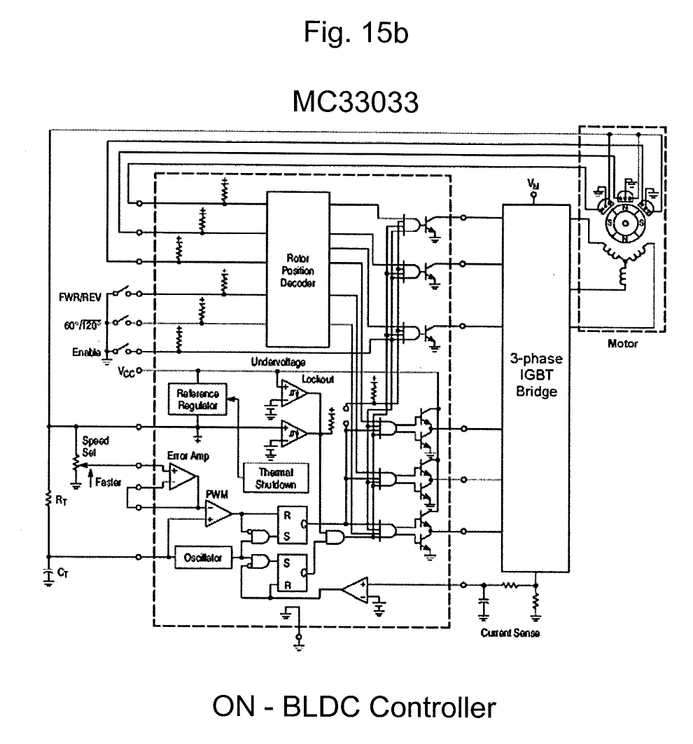

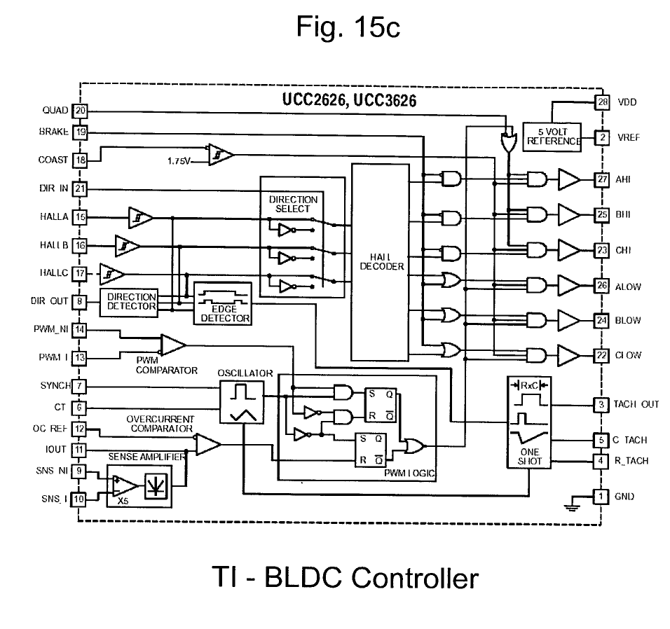

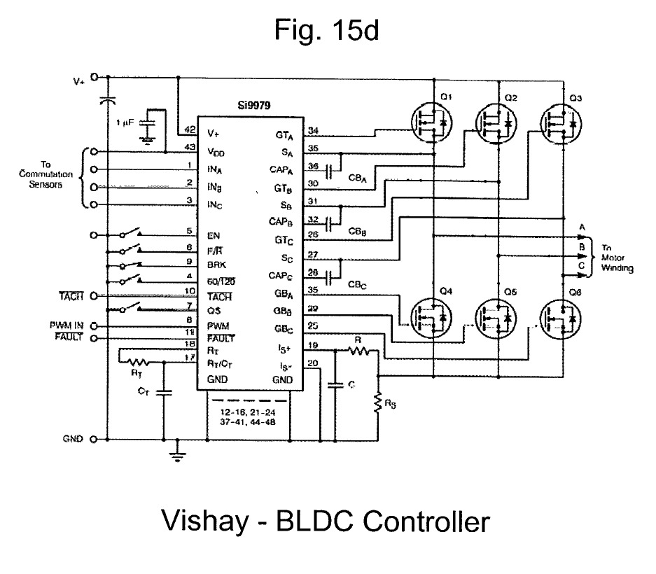

FIGS. 14-15d are schematic diagrams of electronic threshold and comparator circuit with logic circuits providing a method for Electromechanical and Back-EMF rotor position sensing.

FIG. 14 illustrates a threshold, comparator, and selector circuit that monitors the stator voltage and compares it to a preset threshold set point. A stator voltage below the set point indicates that rotor speed is low, requiring the use of electromechanical sensors (typically Hall Effect or Optical) for rotor position sensing. The threshold comparator controls the dual 3-input selector circuit, instructing it to connect the Hall Effect sensors to the Hall Effect inputs of any one of the brushless DC motor controllers illustrated in FIGS. 15a-15c. As the rotor speed increases, the average stator voltage also increases due to increasing Back-EMF. A stator voltage above the set point indicates that the rotor speed is sufficient for the use of Back-EMF rotor position sensing, instructing the selector circuit to connect the Back-EMF sensing comparator outputs to the Hall Effect inputs of the brushless DC motor controller. The Back-EMF sensing comparators monitor the 3-phase stator waveforms creating a rectangular waveform similar to the outputs of the 120 degree spaced Hall Effect sensors. Although the Hall Effect sensors are normally aligned, the accuracy is limited by practical mechanical tolerances and speed variations of the rotor. The Back-EMF voltage comparators provide a precise indication of the exact instant each phase is greater than or less than the associated phase. Back-EMF sensing is independent of mechanical tolerances and speed variations once the speed is high enough to provide a reliable voltage as monitored by the stator voltage threshold comparator. Someone skilled in the art will recognize that this form of sensing works particularly well with 3-phase circuits having 120 degree transistor conduction cycles as is characterized by the brushless DC motor controllers illustrated in FIGS. 15a-15c. At any instantaneous point in the cycle, one phase will be switched high through the associated “high-side” transistor in the 3-phase bridge, a second phase will be switched low through the associated “low-side” transistor in the 3-phase bridge, and a third phase will be “floating”. This third “floating” phase is continuously monitored by the 3-phase comparator circuit until it is higher or lower than the other two phases, causing the appropriate level shifts in the comparator outputs, thus providing precise commutation control.

### Bi-Directional Buck-Boost Pwm Converter

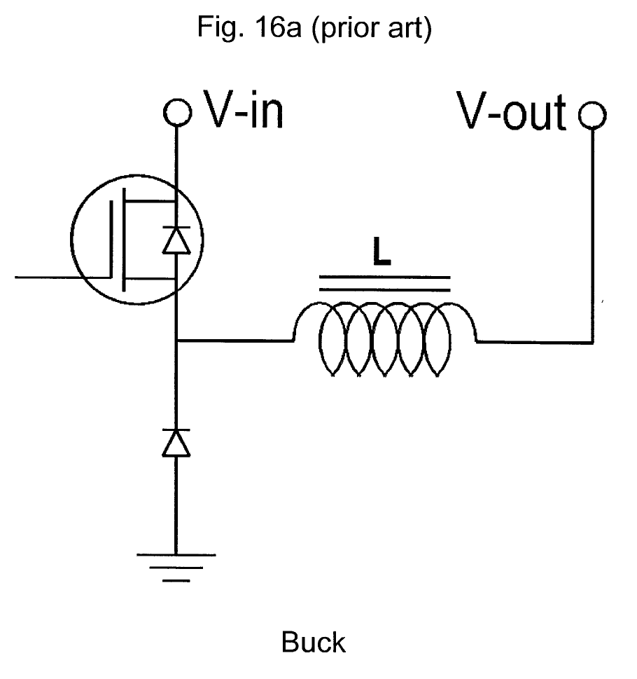

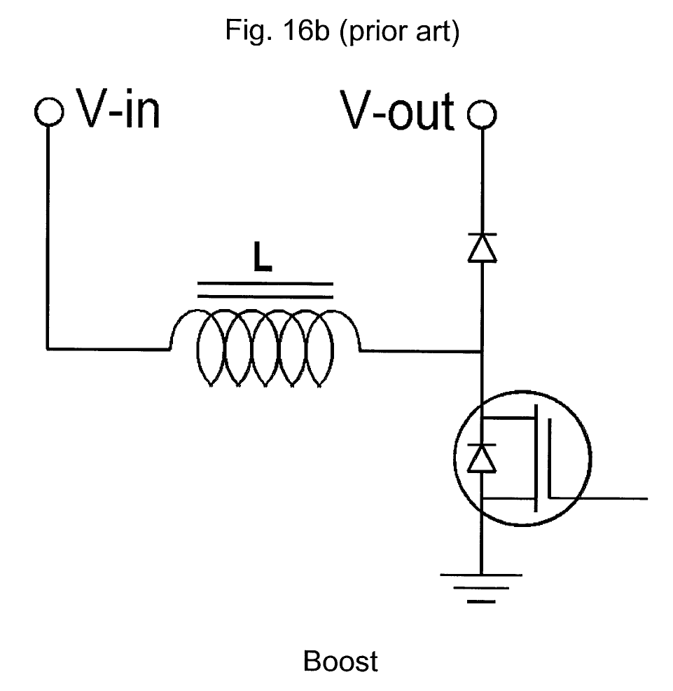

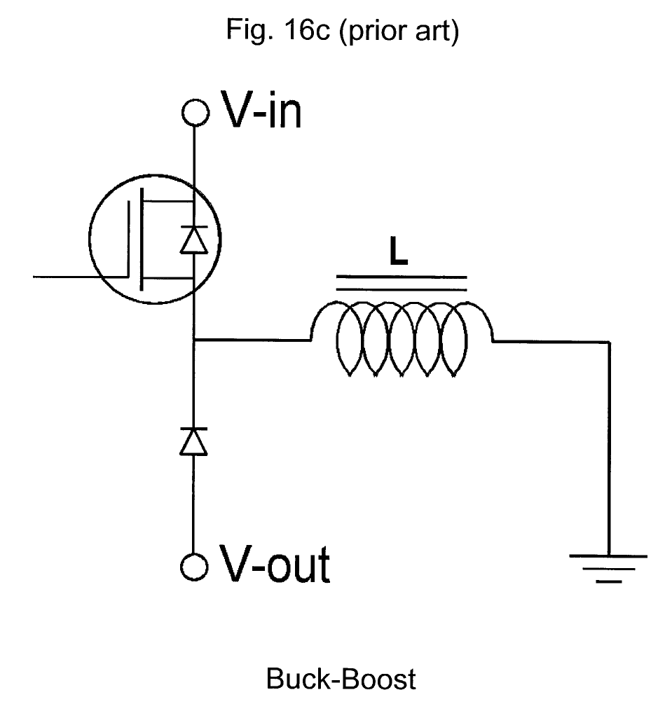

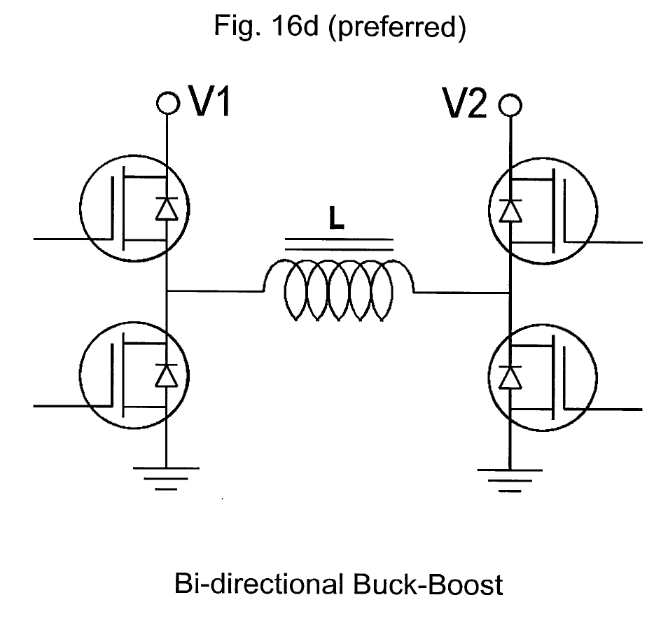

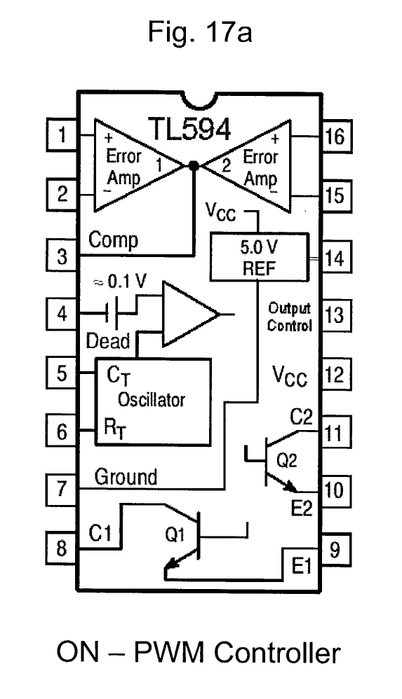

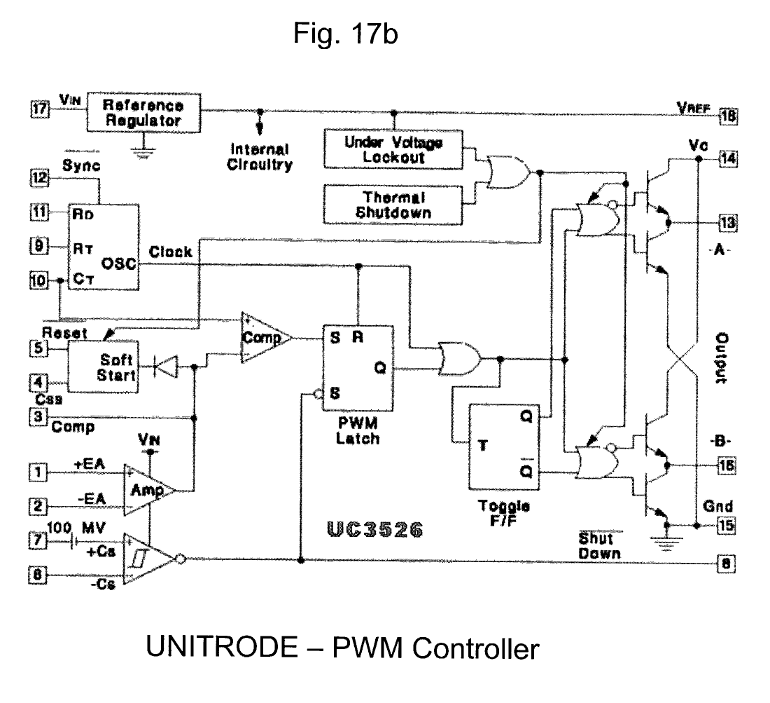

FIGS. 16a-17b are schematic diagrams of “Buck” and “Boost” converters and common “Pulse Width Modulation” (PWM) control circuits available from semiconductor manufacturers.

FIGS. 16a-16c are schematic diagrams illustrating a progression from prior art to a “Bi-directional Buck-Boost” converter using common “H-bridge” or dual “Half-bridge” power MOSFET transistor modules.

FIG. 16a illustrates a prior art “BUCK” converter. Someone skilled in the art will recognize that the output of common PWM controllers shown in FIGS. 17a & 17b can be coupled to the input gate of the power transistor using appropriate driver circuits. The power transistor provides variable width voltage pulses into the inductor by switching on and off. When the transistor switch is on electrical current flows from V-in through the inductor to V-out creating an increasing current and magnetic field in the inductor. When the transistor switches off, the current through the transistor stops, and the magnetic field in the inductor starts to collapse creating a negative voltage that flows through the diode, sustaining current flow through the inductor. This effect is well known to someone skilled in the art and results in a smooth voltage applied to V-out. V-out is always less positive than V-in and is continuously variable proportional to the average width of the input pulses. Current limiting is inherent in the Buck design.

FIG. 16b illustrates a prior art “BOOST” converter. When the transistor is off, current flows from V-in through the inductor and diode to V-out.

When the transistor switches on current flows from V-in through the inductor to ground creating an increasing current and magnetic field in the inductor. When the transistor switches off the current through the transistor stops, and the magnetic field in the inductor starts to collapse creating a more positive voltage that flows through the diode, sustaining current flow through the inductor. This effect is well known to someone skilled in the art and results in an increased voltage applied to V-out. V-out is more positive than V-in and is continuously variable proportional to the average width of the input pulses. Current limiting is not available with this Boost design.

FIG. 16c illustrates a prior art “BUCK-BOOST” converter. When the transistor is on, current flows from V-in through the inductor to ground creating an increasing current and magnetic field in the inductor. When the transistor switches off the current through the transistor stops, and the magnetic field in the inductor starts to collapse creating a negative voltage that flows through the diode to V-out, sustaining current flow through the inductor. This effect is well known to someone skilled in the art and results in a negative voltage applied to V-out. V-out is always negative and is continuously variable proportionate to the average width of the input pulses. Current limiting is inherent in this Buck-Boost design and V-out can be more negative than V-in is positive, but this design is less efficient and cumbersome to use.

FIG. 16d illustrates the preferred “BI-DIRECTIONAL BUCK-BOOST” converter. Dual Buck converters are formed by each of the upper transistors and the free-wheeling diodes inherent in the opposite lower transistors. Dual Boost converters are formed by each of the lower transistors and the free-wheeling diodes inherent in the opposite upper transistors. Someone skilled in the art will recognize that power MOSFET, IGBT, and other transistor modules with built-in free wheeling diodes are readily available from semiconductor manufacturers that provide a variety of current and voltage ratings that match the requirements of the motor or generator and that common PWM controllers can be adapted with minimal effort to provide the appropriate driver circuits and pulse steering control.

### Review Of Prior Art

Electric motors and generators have existed for over one hundred years and as expected, many patents have been issued. These devices rely on the same basic principles of electromagnetic forces. Each improvement expounds upon these principles with a new concept that makes the apparatus more suitable for a particular application. Differentiation between a truly novel idea and one that simply changes a prior concept is not easy. My invention obviously uses many of the techniques put forth in prior art:

On Mar. 14, 1893 a patent was issued to Norman Bassett (U.S. Pat. No. 493,349) illustrating novelty on a laminated armature core, the means to mechanically attach this core to a shaft, and tapered grooves in the core to accept and hold coils of wire. My preferred embodiment does indeed show laminated cores and tapered grooves or wiring slots, however the concept of deliberately spacing the poles does not exist in Bassett's patent. In fact, the patent specifically states the opposite. Lines 64 to 69 of page 1 state that the slots are wide enough to admit the wire, but should approach one another so as to leave a narrow slit, spreading the exposed surface of the armature. Additionally, Bassett's patent relates only to the armature with no mention of the stator or any relationship between the poles on the armature and stator.

On Apr. 24, 1917 a patent was issued to W. A. Turbayne (U.S. Pat. No. 1,223,449) illustrating novelty on a ring wound armature rotating between internal and external field poles. In Turbayne's patent the armature contains no wiring slots, poles or pole segments, which are an integral and necessary part of my invention. The lack of magnetically conductive poles or pole segments in Turbayne's armature increases the gap between the magnetically conductive components by the width of the ring windings, severely limiting the strength of the magnetic fields and overall power and efficiency.

On Jan. 3, 1922 a patent was issued to R. Lundell (U.S. Pat. No. 1,401,996) illustrating novelty on a bi-polar structure having 16 evenly spaced teeth with slots forming two poles on the stator, and 15 evenly spaced teeth forming two poles on the rotating brush-type armature. Interpoles are formed by partly cutting off the adjacent teeth on either side of the teeth where the magnetic lines of force change direction. This is a single-phase two-pole device with five teeth per pole on the stator and seven or eight teeth per pole on the armature. My preferred embodiment gains a significant power and weight advantage over Lundell's patent due to one segment or “tooth” per pole on the rotor, three segments per pole on the stator, and a lateral spacing between the rotor poles instead of an interpole. For comparison purposes, the stator shown in Lundell's patent is roughly equivalent to the rotor illustrated in my preferred embodiment.

On Oct. 24, 1950 a patent was issued to M. J. Rose (U.S. Pat. No. 2,526,690) illustrating a six-pole device where poles on the stator are formed by 36 slots and poles on the armature are formed by 18 slots (described in lines 16 to 20 of column 3). The armature in Rose's patent is roughly equivalent to the stator in my preferred embodiment. However, the stator in Rose's patent has six poles formed by 36 segments or six segments per pole. The concept of lateral pole spacing for eliminating magnetic short circuits does not exist. Comparatively, the rotor in my preferred embodiment has one segment per pole that significantly improves magnetic conduction, and a precise lateral pole spacing relationship that eliminates magnetic short circuits.

On May 16, 1972 a patent was issued to R. E. Phelon (U.S. Pat. No. 3,663,850) illustrating a permanent magnet outer rotor surrounding a three-phase inner stator. This device is similar to the one shown in my preferred embodiment except that the rotor is external and the stator is internal. The patent clearly shows that lateral pole spacing in the rotor is not sufficient to avoid magnetic short circuits in the stator poles. The patent refers to pole spacing only in the context of fastening the permanent magnets with spring member inserts. The concept of laterally spacing the magnets to eliminate magnetic short circuits does not exist.

On May 23, 1972 a patent was issued to Raymond W. Busch (U.S. Pat. No. 3,665,227) illustrating a printed circuit armature rotating between poles formed by gaps in three C-shaped permanent magnets. In Busch's patent the armature contains no magnetically conductive material. For magnetic flux to conduct across the poles it must pass through non-magnetic material across the entire gap of the C-shaped magnet, severely limiting the strength of the magnetic fields and power. To obtain maximum concentration of magnetic flux and therefore power, the teachings of my invention apply to devices with magnetic material forming a complete conduction path for magnetic flux, except for a minimal gap to allow free movement between the rotor and stator.

On Aug. 8, 1972 a patent was issued to Kobayashi et al (U.S. Pat. No. 3,683,248) illustrating a permanent magnet outer rotor surrounding a three-phase inner stator as part of a direct drive phonograph turntable. Kobayashi's invention is very similar to that described in Phelon's (U.S. Pat. No. 3,663,850) patent except it is mainly concerned with reducing wow, flutter and rumble which were characteristic of belt-driven turntables at that time. The concept of lateral spacing of the rotor's drive poles for elimination of magnetic short circuits in the stator does not exist.

On Nov. 27, 1973 a patent was issued to Martin Burgbacher (U.S. Pat. No. 3,775,626) illustrating an external-rotor reluctance motor. Reluctance motors are characterized by an unequal number of unevenly spaced poles where torque is applied by selectively energizing a fraction of the stator poles, pulling the closest rotor poles into alignment. When aligned, the next set of stator poles in the direction of rotation is energized, continuing the application of torque to the rotor. By comparison, my invention achieves a significant gain in power and is characterized by an equal number of equally spaced poles where torque is applied to all poles simultaneously by the right angle force experienced by a current-carrying wire suspended in a magnetic field.

On May 13, 1975 a patent was issued to Wolfgang Kohler (U.S. Pat. No. 3,883,633) illustrating a commutatorless motor characterized by an iron-free rotor within permanent magnet field poles. Kohler's invention is very similar to that described in Busch's (U.S. Pat. No. 3,665,227) patent. In Kohler's patent the rotor also contains no magnetically conductive material. For magnetic flux to conduct across the poles it must pass through non-magnetic material across the entire gap of the permanent magnet severely limiting the strength of the magnetic fields and the power. To obtain maximum concentration of magnetic flux and therefore power, the teachings of my invention apply to devices with magnetic material forming a complete conduction path for magnetic flux, except for a minimal gap to allow free movement between the rotor and stator.

On Aug. 20, 1985 a patent was issued to Kenji Kanayama et al (U.S. Pat. No. 4,536,672) illustrating a flat stator armature disposed within permanent magnet rotors. The armature consists of multiple layers of windings and insulation but has no magnetically conductive material. This is similar to both the Kohler (U.S. Pat. No. 3,883,633) and Busch (U.S. Pat. No. 3,665,227) patents with their inherent limitations as previously mentioned.

On Oct. 25, 1985 a patent was issued to Jayant G. Vaidya (U.S. Pat. No. 4,550,267) illustrating an electromotive machine with multiple sets of windings to establish separate power channels for simultaneous independent transmission of power. The 16-pole permanent magnet rotor and three-phase stator shown in FIG. 1 appear to capture the lateral pole spacing relationship defined in my preferred embodiment. This similarity appears to be purely coincidental, possibly due to the non-detailed block structure of the drawing in FIG. 1. In FIG. 8 of the same patent, Vaidya illustrates a squirrel cage induction rotor with slots for conductors forming poles that do not exhibit the same lateral spacing relationship. Additionally, Vaidya does not recognize the concept of lateral pole spacing or magnetic short circuits anywhere in the patent. The claims focus solely on multiple sets of windings for the purpose of simultaneous independent transmission of power.

On Aug. 2, 1988 a patent was issued to Gregory Leibovich (U.S. Pat. No. 4,761,602) illustrating a compound short-circuit induction machine. Leibovich's invention does not exhibit a lateral pole spacing relationship for the elimination of magnetic short-circuits. Instead it expounds the benefit of selective electrical short-circuits in the conductor loops of a squirrel-cage induction rotor for the distribution of magnetic flux.

On Oct. 3, 1989 a patent was issued to Okamoto et al (U.S. Pat. No. 4,871,934) illustrating stator slot skew relative to rotor slots. This relationship creates a parallelogram geometric relationship between the rotor and stator poles.

However, the concept of lateral pole spacing to avoid lateral magnetic short circuits does not exist. In fact, as is characteristic of prior art induction motors, the pole spacing is purposely minimized in order to maximize magnetic conduction across the gap, inadvertently creating the magnetic short circuit.

On Nov. 27, 1991 a patent was issued to Clyde J. Hancock and James R. Hendershot (U.S. Pat. No. 5,015,903) illustrating an electronically commutated reluctance motor. A lateral pole spacing relationship is evident in this patent but for a different reason. As previously mentioned with regard to Burgbacher's (U.S. Pat. No. 3,775,626) patent, Reluctance Motors are characterized by an unequal number of unevenly spaced poles with only a fraction of the poles applying torque at any time. By comparison, my invention achieves a significant gain in power and is characterized by an equal number of equally spaced poles where all poles apply full torque simultaneously. The characterization of Reluctance Motors exhibiting an unequal number of unevenly spaced poles is further exemplified in patents issued to Itsuki Bahn (U.S. Pat. No. 5,111,091) and James R. Hendershot (U.S. Pat. No. 5,111,095) on May 5, 1992.

On Jun. 30, 1992 a patent was issued to Fritz Hofmann (U.S. Pat. No. 5,126,606) illustrating an electric drive motor with two parallel rows of stator poles. The outer rotors illustrated in FIGS. 11a & 1b of Hofmann's patent contain electrical conductors formed by etching and vapor deposition into the hysteresis electromagnetic powder material that makes up the body of the rotor. These electrical conductors are equivalent to the rotor windings in my preferred embodiment. The lateral spacing between the poles in the rotor provided by these conductors is not sufficient to prevent magnetic short circuits in the stator pole segments. For comparison purposes, the two parallel rows of inner stator pole segments in Hofmann's patent form a 2-phase stator that is roughly equivalent to the outer 3-phase stator in my preferred embodiment.

On Aug. 3, 1993 a patent was issued to De Filippis (U.S. Pat. No. 5,233,250) illustrating three-phase brushless DC motors with half-wave control. The 1/3 angular extent of the opening versus the 2/3 angular extent of each permanent magnet achieves a beneficial lateral spacing relationship that eliminates lateral magnetic short circuits. However, the trapezoidal waveform indicates no attempt to create a sine waveform and that the geometric relationship between the rotor and stator poles is rectangular. Also, someone skilled in the art will recognize that a half-wave control circuit is simpler and less costly than a full-bridge, full-wave control circuit, but is also less efficient and undesirable in high power applications.

Finally, on Sep. 23, 1997 a patent was issued to Everton and assigned to Unique Mobility, Inc. (U.S. Pat. No. 5,670,838) illustrating Electrical Machines, or more specifically, an “electromechanical transducer”. The preferred embodiment illustrates an interpole that achieves a beneficial lateral pole spacing relationship in an attempt to create a rounded waveform. However, the distorted waveform indicates an attempt to create a sine waveform and that the geometric relationship between the rotor and stator poles is rectangular. Also, someone skilled in the art will recognize that lateral magnetic short circuits occur in the interpole due to it's proximity to the stator pole segments and the adjacent rotor poles in a less efficient and undesirable manner for high power applications.

It is evident that much effort has been expended into the improvement of high torque generators and motors. However, it appears that the unique combinations of fundamental concepts outlined in this document have eluded the originators of prior art. I have spent over 20 years researching and building prototypes to provide practical solutions to high power electrical apparatus. Many existing and future designs could benefit significantly from the recognition of these concepts by making design changes encompassing one or more of them. It is my contention that these fundamental concepts represent a culmination of the inventive process and should be granted protection from copying under the international laws of intellectual property rights.

It will be apparent to one skilled in the art that modifications may be made to the illustrated embodiments without departing from the spirit and scope of the invention as claimed.

The embodiments of the invention in which an exclusive property or privilege is claimed are defined as follows:

1. A combination of fundamental geometric relationships between the rotor and stator magnetic poles in an electric motor or generator that eliminates lateral magnetic short circuits, and provides axial extendibility, and induces a sine waveform in the main windings; where:
the lateral distance between adjacent magnetic poles in the rotor is sufficiently greater than the pole segment width in the stator to eliminate lateral magnetic short circuits, and
the magnetic poles are axially extendable either by an axially stackable claw structure or by axial slots, and
a sine waveform is induced in the main windings by a trapezoidal, parallelogram, skew, helix, arc, or other non-rectangular geometric relationship between the rotor and stator poles.

2. A fundamental geometric relationship between the rotor and stator magnetic poles providing a Magnetic Flux concentration proportional to the surface area of Permanent Magnets coupled to rotor pole pieces versus the surface area of the rotor pole pieces that interact with the stator; where:
the rotor poles are formed by axial slots or claw structure, and
the concentration is a combination of the radial and axial surface area of the Permanent Magnet coupling.

3. A brushless, speed independent, rotating inductive coupler providing regulating control of rotor voltage and current; containing:
an electronic chopper, and
a rotating non-contact AC transformer, and
a rotor mounted electronic rectifier.

4. A pulse width modulation (PWM) circuit topology providing continuously variable bi-directional Buck-Boost electrical current and voltage control and matching; where:
an H-bridge is formed by four power transistors and parallel reverse free-wheeling diodes that control electrical currents in a bridge-connected power inductor, and
Buck PWM controllers provide upper H-bridge bi-directional transistor switching and opposite H-Bridge lower diode conduction, and
Boost PWM controllers provide lower H-bridge bi-directional transistor switching and opposite H-bridge upper diode conduction.

5. A precise and variable speed rotor position sensing provided by a threshold and comparator circuit that switches between electromechanical sensing and Back-EMF sensing; where:
Electromechanical sensors provide low speed sensing, and
Back-EMF comparators provide medium to high speed sensing.
